(19) United States
(12) Patent Application Publication
(10) Pub. No.: US 2011/0199600 A1
(43) Pub. Date: Aug. 18, 2011

(54) COLLECTOR ASSEMBLY, RADIATION SOURCE, LITHOGRAPHIC APPARATUS AND DEVICE MANUFACTURING METHOD

(75) Inventor: Wouter Anthon Soer, Eindhoven (NL)

(73) Assignee: ASML NETHERLANDS B.B.

(21) Appl. No.: 13/124,501

(22) PCT Filed: Sep. 3, 2009
(86) PCT No.: PCT/EP09/06373

§ 371 Date: Apr. 15, 2011

(30) Foreign Application Priority Data
Oct. 17, 2008 (US) 61/136962

(51) Int. Cl. G03B 27/54

(52) U.S. Cl. 355/67

(57) ABSTRACT

A collector assembly includes a first collector mirror for reflecting radiation from a radiation emission point, such as an extreme ultraviolet radiation emission point, to an intermediate focus from where the radiation is used in the lithography apparatus for device manufacture. A second collector mirror, forward of the radiation emission point, collects additional radiation, reflecting it back to a third mirror and from there to the intermediate focus. The mirrors may allow radiation to be collected with high efficiency and without increase in the etendue. The collector assembly may reduce or remove non-uniformity in the collected radiation, for instance arising from obscuration of collected radiation by a laser beam stop used to prevent laser excitation radiation from entering the lithographic apparatus.

### FIELD

The present invention relates to lithographic apparatus and in particular to a radiation source and a collector assembly to provide conditioned radiation, such as extreme ultra-violet (EUV) radiation.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned.

Lithography is widely recognized as one of the key steps in the manufacture of ICs and other devices and/or structures. However, as the dimensions of features made using lithography become smaller, lithography is becoming a more critical factor for enabling miniature IC or other devices and/or structures to be manufactured.

A theoretical estimate of the limits of pattern printing can be given by the Rayleigh criterion for resolution as shown in equation (1):

CD=k₁λ/ NA_{PS} (1)

where λ is the wavelength of the radiation used, NA_{PS} is the numerical aperture of a projection system used to print the pattern on the substrate, k₁ is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NA_{PS} or by decreasing the value of k₁.

In order to shorten the exposure wavelength and, thus, reduce the minimum printable size, it has been proposed to use an EUV radiation source. An EUV radiation source is configured to output a radiation wavelength of about 13 nm. Thus, an EUV radiation source may constitute a significant step toward achieving printing of small features. Such radiation is also termed soft x-ray, and possible sources include, for example, a laser-produced plasma source, a discharge produced plasma source, or synchrotron radiation from an electron storage ring.

EUV radiation and beyond EUV radiation may, for instance, be produced using a discharge produced plasma (DPP) radiation generator. A plasma is created by, for example, passing an electrical discharge through a suitable material (e.g. a gas or vapor). The resulting plasma may be compressed (i.e. be subjected to a pinch effect), typically by means of a laser at which point electrical energy is converted into electromagnetic radiation in the form of EUV radiation (or beyond EUV radiation). Various devices are known in the art to generate EUV radiation.

Alternatively, EUV radiation may be produced using a laser produced plasma (LPP) radiation generator. The plasma may be created, for example, by directing a laser at particles of a suitable material (e.g. tin), or by directing a laser at a stream of a suitable gas (e.g. Sn vapor, SnH₄, or a mixture of Sn vapor and any gas with a small nuclear charge (for example from H₂ up to Ar)). The resulting plasma emits EUV radiation (or beyond EUV radiation). The target stream may be radiated by high-power laser beam pulses, typically from an Nd:YAG laser, the pulses heating the target material to produce a high temperature plasma which emits the EUV radiation. The frequency of the laser beam pulses is application specific and depends upon a variety of factors. The laser beam pulses require adequate intensity in the target area in order to provide enough heat to generate the plasma.

### SUMMARY

The radiation emitted from the radiation emission point of a radiation generator, such as an EUV radiation generator, for lithography, is typically collected using a collector assembly arranged to direct the EUV radiation to a collector location or intermediate focus from where it continues on for use in a lithographic process or apparatus. A collector assembly may, for instance, have a reflective normal incidence collector of ellipsoidal shape, with the radiation emission point at one (first) focal point of the ellipsoid such that the radiation is formed into a beam passing out of the collector assembly at a collection aperture and focused onto another (second) focal point of the ellipsoid, the so-called intermediate focus, which acts as the collection location.

Typically, for instance, if the radiation generator is a LPP radiation generator of EUV radiation, the collector assembly may be provided with a beam stop arranged to block laser radiation used in generating the EUV radiation. The beam stop is arranged to prevent the laser radiation shining directly out of the collection aperture of the collector assembly and propagating directly into the lithographic apparatus. One problem with this arrangement is that the beam stop may lead to obscuration of part of the EUV radiation beam passing out through the collection aperture, thus presenting a strong non-uniformity in a far field image of the radiation as emanating from the radiation emission point. The latter image is also referred to as the source image, hereinafter. The presence of the obscuration makes the source image annular rather than circular. A far field image may, for example, occur in a Fourier Transform plane associated to an object plane of the projection system such as the plane where in use the patterned surface of the patterning device is disposed. In general, strong non-uniformity in the source image is not desirable since it must be compensated for in an illuminator forming the next stage of the optical system of the lithography apparatus. Such compensation may result in optical losses in the illuminator, for example because an additional mirror is needed leading to further reflective losses.

Typically, the reflective surfaces of the mirrors used in the optical system of the lithographic apparatus are coated with a reflective coating to enhance their reflectance. It may be important that the reflective coating material does not degrade in response to high energy ions generated, for instance, by plasma that may impinge upon the reflective surface and detach the reflective coating material. A suitable coating for use with a plasma radiation generator is a silicon/molybdenum (Si/Mo) multilayer. However, the Si/Mo coating on collector optics will typically only reflect about 70% of the EUV radiation impinging thereon, even at its theoretical maximum performance. Also, the reflective efficiency of such a multilayer coating is highly dependent upon the angle of incidence of radiation.

It is desirable, for example, that as much of the radiation as possible is collected and directed to the collection location in order to improve the efficiency of the collector assembly and to provide a more effective radiation source for use in lithography. For instance, the higher the intensity of the radiation for a particular photolithography process, the less time will be needed to properly expose the various photoresists that may be exposed for providing patterning. Reduction in the necessary exposure time means that more circuits, devices, etc. can be fabricated, increasing throughput efficiency and decreasing manufacturing costs.

Also, an excitation power required to produce radiation may be reduced, thus conserving the input energy required and potentially extending the life of the excitation source. It is also desirable to reduce or remove obscuration from the collected radiation and to increase the radiation collected for the illuminator of a lithography apparatus without increasing the etendue (acceptance angle) of the illuminator.

An embodiment of the invention addresses one or more of the above-mentioned problems.

In an embodiment, there is provided a collector assembly for a lithographic apparatus comprising:
a first collector mirror having a first focus and a second focus, the second focus being further from the first collector mirror than the first focus, the first and second foci defining an optical axis and defining first and second focal planes passing through the first and second focus respectively, and each normal to the optical axis;
wherein the first collector mirror is arranged to collect, in use, first radiation directly from a radiation emission point positioned at the first focus and to reflect the first radiation forwards to the second focus;
a second collector mirror positioned between the first and second focal planes and arranged to collect second radiation directly from the radiation emission point; and
a third mirror positioned substantially on the optical axis between the first focal plane and the second collector mirror,
wherein the second collector mirror is arranged to reflect the second radiation onto the third mirror and the third mirror is arranged to reflect the second radiation to the second focus and wherein the second collector mirror is arranged to not substantially block the second radiation reflected from the third mirror, or the first radiation reflected from the first collector mirror, to the second focus.

By the term “directly” is meant that radiation passes from the emission point to a collector mirror without being significantly reflected or refracted en route.

In an embodiment, the first collector mirror is a concave mirror arranged about the optical axis with substantially circular symmetry. The first collector mirror may be an ellipsoidal mirror.

In an embodiment, the second collector mirror is arranged so as to not substantially block the second radiation reflected from the third mirror to the second focus. The second collector mirror may be a mirror located off the optical axis. The second collector mirror may be an annular concave mirror arranged about the optical axis with substantially circular symmetry. This provides an opening in the second mirror around the optical axis through which the second radiation, reflected from the third mirror, can pass through the second mirror to reach the second focus.

The third mirror is suitably arranged about the optical axis with substantially circular symmetry. The third mirror may be a convex mirror, but other shapes, for example a conical or more complex shape, may be used.

The radiation emission point may be an EUV radiation emission point. In particular, it may be the radiation emission point of a laser produced plasma (LPP) radiation generator. The LPP radiation generator may comprise a laser, the laser being arranged to direct a laser beam onto an EUV radiation emission point through an aperture in the first collector mirror. In an embodiment, the laser is arranged to direct the laser beam substantially along the optical axis and a beam stop is positioned to substantially block the laser beam from passing directly through to the second focus. By “emission point” is meant a region or volume from which in use radiation is emitted.

The third mirror is suitably positioned fully within the solid angle subtended by the aperture in the first collector mirror at the second focus, or fully within the solid angle subtended by the beam stop at the second focus. In an embodiment, the third mirror is positioned fully within whichever provides the largest solid angle. This helps ensure that the third mirror does not substantially block first radiation directly reflected by the first mirror to the second focus. The third mirror may be positioned on the beam stop. In other words, the beam stop may comprise the third mirror mounted upon it or the third mirror may be unitary with the beam stop.

Any one of, or any combination of the first collector mirror, the second collector mirror and the third mirror may be a silicon/molybdenum multilayer mirror. In an embodiment, the mirror(s) will be a silicon/molybdenum multilayer mirror adapted for high reflectivity at the wavelength of the radiation generated by the EUV radiation generator.

In an embodiment there is provided a radiation source including the collector assembly as detailed herein, wherein the radiation emission point is a radiation emission point of an extreme ultra-violet radiation generator. The extreme ultra-violet radiation generator may be a laser produced plasma radiation generator. The radiation source may comprise a laser arranged to direct a laser beam onto the radiation emission point through an aperture in the first collector mirror. As detailed above for the collector assembly, the laser may be arranged to direct the laser beam substantially along the optical axis whilst the collector assembly comprises a beam stop positioned to substantially block the laser beam from passing directly through to the second focus. In an embodiment, the third mirror is positioned at the beam stop.

In an embodiment, there is provided a lithographic apparatus comprising the radiation source or the collector assembly as detailed herein.

In an embodiment, there is provided a device manufacturing method comprising projecting a patterned beam of radiation onto a substrate, wherein the radiation is provided by the radiation source as detailed herein or collected by the collector assembly as detailed herein.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a lithographic apparatus according to an embodiment of the invention;

FIG. 2 is a more detailed, but schematic, illustration of the lithographic apparatus of FIG. 1; and

FIG. 3 shows a schematic cross-sectional view of a radiation source according to an embodiment of the invention.

### DETAILED DESCRIPTION

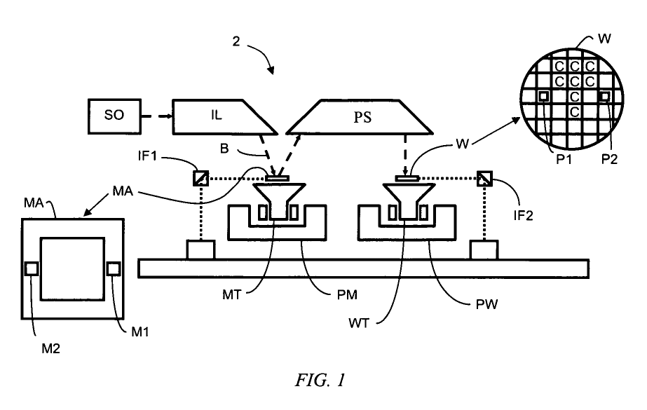

FIG. 1 schematically depicts a lithographic apparatus 2 according to an embodiment of the invention using the collector assembly described herein. The apparatus 2 comprises:
an illumination system (illuminator) IL configured to condition a radiation beam B (e.g. EUV radiation);
a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and
a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device. It holds the patterning device in a manner that depends on the orientation of the patterning device, the design of the lithographic apparatus 2, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

Examples of patterning devices include masks and programmable mirror arrays. Masks are well known in lithography, and typically, in an EUV radiation (or beyond EUV radiation) lithographic apparatus, would be reflective. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system. Usually, in an EUV (or beyond EUV) radiation lithographic apparatus the optical elements will be reflective. However, other types of optical element may be used. The optical elements may be in a vacuum. Any use of the term “projection lens” herein may be considered as synonymous with the more general term “projection system”.

As here depicted, the apparatus 2 is of a reflective type (e.g. employing a reflective mask).

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The radiation source SO includes an EUV radiation generator, such as for example an LPP radiation generator, and a collector assembly for collecting radiation emanating from a radiation emission point of the EUV radiation generator. In an embodiment, the source SO may include the collector assembly. Alternatively, the collector assembly may be part of the lithographic apparatus 2, or may be part of both the source SO and the lithographic apparatus 2. In an embodiment, the source and the lithographic apparatus may be separate entities. In such a case, where the radiation source SO includes the collector assembly, the collector assembly is not considered to form part of the lithographic apparatus. Where the source SO including the collector assembly is a separate entity, the radiation beam may be passed from the collector assembly of the radiation source SO to the illuminator IL with the aid of a beam delivery system comprising, for example, suitable directing mirrors and/or a beam expander. In other cases the source and the collector assembly (whether the collector assembly is part of the source or otherwise part of the lithographic apparatus) may be an integral part of the lithographic apparatus. The collector assembly, the source SO and the illuminator IL, together with the beam delivery system if required, may be referred to as a radiation system.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator and a condenser. The illuminator IL may be used to condition the radiation beam B to have a desired uniformity and intensity distribution in its cross-section.

The radiation beam B is incident on the patterning device (e.g., mask) MA, which is held on the support structure (e.g., mask table) MT, and is patterned by the patterning device. Having been reflected by the patterning device MA, the radiation beam B passes through the projection system PS, which focuses the beam onto a target portion C of the substrate W. With the aid of the second positioner PW, and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Mask MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus 2 could be used in at least one of the following modes:

1. In step mode, the support structure MT and the substrate table WT are kept essentially stationary, while an entire pattern imparted to the radiation beam is projected onto a target portion C at one time (i.e. a single static exposure). The substrate table WT is then shifted in the plane of the substrate so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

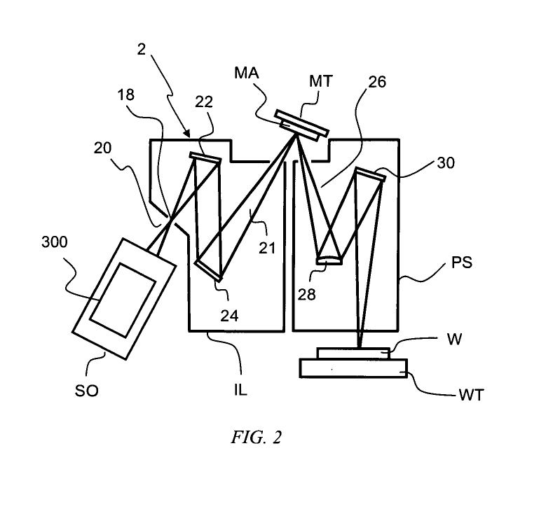

FIG. 2 shows the lithographic apparatus 2 of FIG. 1 in more detail, but still in schematic form, including a collector assembly 300 (in this case part of the radiation source SO) according to an embodiment of the invention, an illuminator IL (sometimes referred to as an illumination system), and the projection system PS.

Radiation from a radiation generator is focused by the collector assembly into a virtual source point collection focus 18 at an entrance aperture 20 of the illuminator IL. A beam of radiation 21 is reflected in the illuminator IL via first and second reflectors 22, 24 onto a patterning device MA positioned on support structure MT. A patterned beam of radiation 26 is formed which is imaged by projection system PS via first and second reflective elements 28, 30 onto a substrate W held on a substrate table WT.

It will be appreciated that more or fewer elements than shown in FIG. 2 may generally be present in the radiation source SO, illumination system IL, and projection system PS. For instance, in an embodiment, the lithographic apparatus 2 may comprise one or more transmissive or reflective spectral purity filters.

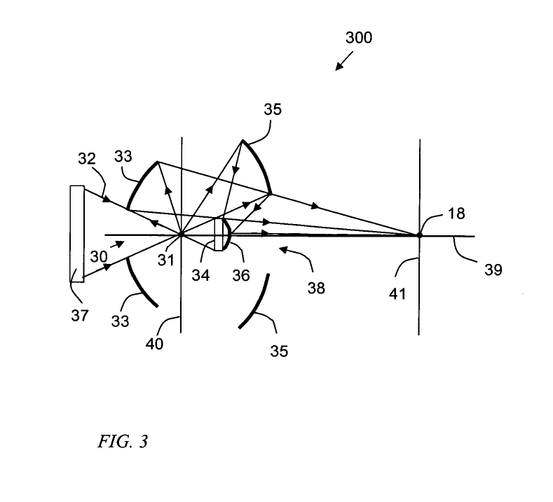

FIG. 3 shows a schematic cross sectional view of an embodiment of a collector assembly 300 according to an embodiment of the invention. The radiation emission point of a LPP radiation generator is located at a first focus 31 of a first collector mirror 33. In an embodiment, the first collector mirror 33 is a concave mirror arranged about the optical axis with substantially circular symmetry. The first collector mirror may be an ellipsoidal mirror. In use, a laser beam 32 from a laser 37 is directed onto the LPP EUV radiation emission point 31 through an aperture 30 in the first collector mirror 33.

First EUV radiation from the LPP generator's radiation emission point at the first focus 31 falls directly onto the first collector mirror 33 and is reflected to the second focus 18. The first focus 31 and the second focus 18 define an optical axis 39 and also define first 40 and second 41 focal planes, respectively, normal to the optical axis 39. The laser beam 32 is directed substantially along the optical axis from the laser 37 to the radiation emission point of the LPP radiation generator for excitation of a plasma disposed at the first focus 31 such as to provide EUV radiation emanating from the radiation emission point. A beam stop 34 is positioned on the optical axis between the first focus 31 and the second focus 18 to block the laser beam 32 and to prevent the beam from passing directly through the collector assembly to the second focus 18 and into the lithography apparatus where it may disrupt or interfere with patterning. A third mirror 36, which may be a convex mirror, is located on the side of the beam stop 34 opposite to the laser 37 and the first focus 31. The third mirror may be mounted on the back of the laser beam stop 34. The reflective surface of the third mirror may have a central portion shaped as a conical surface. In an embodiment the apex of the conical surface is centered with respect to the optical axis 39. The third mirror acts to fill in a cone of obscuration in the collected radiation from the first collector mirror 33 arising from the beam stop 34.

A second collector mirror 35, which is an annular concave mirror, is positioned around the optical axis, between the first and second focal planes, and has an opening 38 through which the first EUV radiation, reflected from the first collector mirror 33, can pass through the second collector mirror 35 to the second focus 18.

Second EUV radiation emanating from the radiation emission point of the LPP radiation generator at the first focus 31 falls directly onto a reflective surface of the second collector mirror 35, and is reflected towards the third mirror 36 at the beam stop 34. The second collector mirror 35 collects second EUV radiation which leaves the LPP emission point in a forward direction (i.e. towards the second focus 18) relative to a focal plane passing through the first focus 31, and reflects this second EUV radiation back towards the focal plane of the first focus 31 and back towards the third mirror 36. The second radiation is then reflected by the third mirror 36 to be focused at the second focus 18.

It can be seen from FIG. 3 that, in the absence of the second mirror 35 and the third mirror 36, the beam stop 34 would lead to a central cone of obscuration subtended by the beam stop 34 at the second focus 18 having no EUV radiation within it. In general, strong non-uniformity, such as a central cone of obscuration, is not desirable since it must be compensated for in the illuminator. This compensation generally leads to optical losses in the illuminator, for example because an additional mirror is needed for compensation. In the embodiment, the second 35 and third 36 mirrors direct second EUV radiation from the radiation emission point of the LPP radiation generator into this cone of obscuration leading to more angularly uniform illumination at the second focus 18 and a more uniform illumination at a far field (Fourier Transform) plane associated with the second focus 18. This means that less manipulation of the radiation may be needed subsequently in the illuminator IL to provide uniform illumination, meaning that there should be fewer optical losses.

Additionally or alternatively, the additional collected radiation is not wasted because it is directed to the second focus within the existing etendue of the first radiation falling within the acceptance angle of the illuminator.

In a typical arrangement, the collector would subtend a solid angle of around 5 steradians at the emission point, which, at an average collector reflectivity of 60% leads to a theoretical collection efficiency of about 24% out of 4π steradians. In principle, the collection efficiency could be increased by increasing the collection angle, i.e., by making the collector subtend a greater solid angle at the emission point. However, there are some practical limitations to this approach:

i) angles of incidence on the reflective surface of the first collector mirror 33 (measured from the normal) become larger as the collection angle increases. A multilayer mirror, such as a silicon/molybdenum layered mirror used for EUV radiation, has a relatively low reflectivity for an angle of incidence between about 30° and 55° so that an increase in collection angle contributes relatively little to the total amount of collected radiation because of the reduced reflectivity arising from a larger angle of incidence for any extra, collected first radiation,

ii) the etendue increases in accordance with the collected solid angle. Therefore, at least part of any such additionally collected radiation would fall outside the etendue that is accepted by and characteristic for the illuminator and so would be lost.

As this embodiment of the invention removes the central obscuration from the source image, the size of the aperture 30 in the first collector mirror 33 may be increased without adversely affecting the uniformity of the source image, provided that the third mirror is arranged to provide collected radiation to fill the resulting cone of obscuration. This may be advantageous for several reasons, for example, it allows the numerical aperture of any optics focusing the laser beam onto the LPP emission point to be increased. It also gives scope for the placement of a debris mitigation tool partly within the aperture 30.

The arrangement of the second mirror 35 and third mirror 36 helps ensure that radiation incident on the mirrors may be at low incidence angle, suitably less than 35°, or even less than 30° or less than 25° such that the reflectivity of the mirrors is high, leading to lower optical losses.

Although specific reference may be made in this text to the use of lithographic apparatus in the manufacture of integrated circuits as the devices, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. by lithography, particularly high resolution lithography.

Although specific reference may have been made above to the use of embodiments of the invention in the context of optical lithography, it will be appreciated that the invention may be used in other applications, for example imprint lithography, and where the context allows, is not limited to optical lithography.

The terms “radiation” and “beam” used herein encompass all types of electromagnetic radiation, including ultraviolet (UV) radiation (e.g. having a wavelength of or about 365, 355, 248, 193, 157 or 126 nm) and EUV radiation (e.g. having a wavelength in the range of 5-20 nm).

While specific embodiments of the invention have been described above, it will be appreciated that the invention may be practiced otherwise than as described. For instance, the EUV radiation emission point may be part of a DPP radiation generator rather than an LPP radiation generator.

The descriptions above are intended to be illustrative, not limiting. Thus, it will be apparent to one skilled in the art that modifications may be made to the invention as described without departing from the scope of the claims set out below.

1. A collector assembly for a lithographic apparatus comprising:
a first collector mirror having a first focus and a second focus, the second focus being further from the first collector mirror than the first focus, the first and second foci defining an optical axis and defining first and second focal planes passing through the first and second focus respectively, and each normal to the optical axis, wherein the first collector mirror is arranged to collect first radiation directly from a radiation emission point positioned at the first focus and to reflect the first radiation forwards to the second focus;
a second collector mirror positioned between the first and second focal planes and arranged to collect second radiation directly from the radiation emission point; and
a third mirror positioned substantially on the optical axis between the first focal plane and the second collector mirror,
wherein the second collector mirror is arranged to reflect the second radiation onto the third mirror and the third mirror is arranged to reflect the second radiation to the second focus and wherein the second collector mirror is arranged to not substantially block the second radiation reflected from the third mirror, or the first radiation reflected from the first collector mirror, to the second focus.

2. The collector assembly of claim 1 , wherein the second collector mirror is an annular concave mirror arranged about the optical axis with substantially circular symmetry.

3. The collector assembly of claim 2, wherein the third mirror is a convex mirror.

4. The collector assembly of claim 1, wherein one or more of the mirrors selected from the first collector mirror, the second collector mirror or the third mirror, is a silicon/molybdenum multilayer mirror.

5. The collector assembly of claim 1, wherein the first collector mirror is provided with an aperture arranged to direct through the aperture a laser beam onto the radiation emission point.

6. The collector assembly of claim 5, further comprising a beam stop positioned to substantially block, in use, the laser beam from passing directly through to the second focus.

7. The collector assembly of claim 6, wherein the third mirror is positioned at the beam stop.

8. A radiation source comprising:
a collector assembly comprising
a first collector mirror having a first focus and a second focus, the second focus being further from the first collector mirror than the first focus, the first and second foci defining an optical axis and defining first and second focal planes passing through the first and second focus respectively, and each normal to the optical axis, wherein the first collector mirror is arranged to collect first radiation directly from a radiation emission point positioned at the first focus and to reflect the first radiation forwards to the second focus:
a second collector mirror positioned between the first and second focal planes and arranged to collect second radiation directly from the radiation emission point; and
a third mirror positioned substantially on the optical axis between the first focal plane and the second collector mirror,
wherein the second collector mirror is arranged to reflect the second radiation onto the third mirror and the third mirror is arranged to reflect the second radiation to the second focus and wherein the second collector mirror is arranged to not substantially block the second radiation reflected from the third mirror, or the first radiation reflected from the first collector mirror, to the second focus, and
wherein the radiation emission point is a radiation emission point of an extreme ultra-violet radiation generator.

9. The radiation source of claim 8, wherein the extreme ultra-violet radiation generator is a laser produced plasma radiation generator.

10. The radiation source of claim 9, further comprising a laser arranged to direct a laser beam onto the radiation emission point through an aperture in the first collector mirror.

11. The radiation source of claim 10, wherein the laser is arranged to direct the laser beam substantially along the optical axis and wherein the collector assembly comprises a beam stop positioned to substantially block the laser beam from passing directly through to the second focus.

12. The radiation source of claim 11, wherein the third mirror is positioned at the beam stop.

13. A lithographic apparatus comprising:
a collector assembly comprising
a first collector mirror having a first focus and a second focus, the second focus being further from the first collector mirror than the first focus, the first and second foci defining an optical axis and defining first and second focal planes passing through the first and second focus respectively, and each normal to the optical axis, wherein the first collector mirror is arranged to collect first radiation directly from a radiation emission point positioned at the first focus and to reflect the first radiation forwards to the second focus;
a second collector mirror positioned between the first and second focal planes and arranged to collect second radiation directly from the radiation emission point; and
a third mirror positioned substantially on the optical axis between the first focal plane and the second collector mirror,
wherein the second collector mirror is arranged to reflect the second radiation onto the third mirror and the third mirror is arranged to reflect the second radiation to the second focus and wherein the second collector mirror is arranged to not substantially block the second radiation reflected from the third mirror, or the first radiation reflected from the first collector mirror, to the second focus.

14. A device manufacturing method comprising:
projecting a patterned beam of radiation onto a substrate, wherein the radiation is provided by a radiation source comprising a collector assembly comprising
a first collector mirror having a first focus and a second focus, the second focus being further from the first collector mirror than the first focus, the first and second foci defining an optical axis and defining first and second focal planes passing through the first and second focus respectively, and each normal to the optical axis, wherein the first collector mirror is arranged to collect first radiation directly from a radiation emission point positioned at the first focus and to reflect the first radiation forwards to the second focus;
a second collector mirror positioned between the first and second focal planes and arranged to collect second radiation directly from the radiation emission point; and
a third mirror positioned substantially on the optical axis between the first focal plane and the second collector mirror,
wherein the second collector mirror is arranged to reflect the second radiation onto the third mirror and the third mirror is arranged to reflect the second radiation to the second focus and wherein the second collector mirror is arranged to not substantially block the second radiation reflected from the third mirror, or the first radiation reflected from the first collector mirror, to the second focus, and
wherein the radiation emission point is a radiation emission point of an extreme ultra-violet radiation generator.
